(19) United States
(12) Patent Application Publication
(10) Pub. No.: US 2025/0340767 A1
(43) Pub. Date: Nov. 6, 2025

(54) ADHESIVE FORMULATIONS

(71) Applicant: BINDETHICS LTD., Yorkshire (GB)

(72) Inventor: Victoria Garcia Flores, Yorkshire (GB)

(73) Assignee: BINDETHICS LTD., Yorkshire (GB)

(21) Appl. No.: 19/266,748

(22) Filed: Jul. 11, 2025

Related U.S. Application Data
(63) Continuation of application No. PCT/GB2024/052017, filed on Jul. 31, 2024.

(30) Foreign Application Priority Data
Jul. 31, 2023 (GB) 2311778.1

(51) Int. Cl. C09J 189/00; C08K 5/092; C09J 5/00

(52) U.S. Cl. CPC C09J 189/00; C08K 5/092; C09J 5/00; C09J 2301/408; C09J 2400/283; C09J 2400/303; C09J 2489/00

(57) ABSTRACT

Provided herein are formulations and methods for adhering substrates. The formulations comprise yeast; carboxylic acid; and solvent.

### CROSS-REFERENCE TO RELATED APPLICATIONS

This application is a Continuation of PCT/GB2024/052017, filed Jul. 31, 2024, which claims priority to GB 2311778.1, filed Jul. 31, 2023, the entire contents of which are incorporated herein in their entirety.

### FIELD OF THE DISCLOSURE

The present disclosure relates generally to adhesive formulations.

### BACKGROUND

Kadimaliev et al, BioResources (2012) 7(2), 1984-1993 states “During the production of beer large amounts of yeast waste are generated. This paper considers the possible making of environmentally friendly adhesive compositions from such wastes. Chemical treatment of yeast wastes increases their adhesive characteristics. Chemical cross-linking with glutaric aldehyde and biological cross-linking by enzyme transglutaminase improves the moisture resistance of the adhesive compositions. In terms of their physical and mechanical parameters they are not inferior to glues of natural origin and can be used for bonding paper, cardboard, and wood. The bonding strength of paper was 421.8 N/m, and that of wood was 27.8 MPa.”

WO2020104811A1 discloses “a method for preparing a binder precursor, the method comprising the steps of: i) mixing (A) fungi or glucan and (B) starch with an alkaline agent in the presence of an aqueous solvent system to form an alkaline composition; ii) mixing the alkaline composition with an acidic agent to form a mixture; and iii) drying the mixture and forming a powder therefrom, so as to form a powdered binder precursor”.

### SUMMARY

The present disclosure is based, at least in part, on findings that adhesives can be made that have advantages over other adhesives, for example adhesives can be made that are relatively cheap, that are relatively environmentally sustainable, and/or that are relatively safe to humans and animals exposed to such. In certain embodiments, compositions and formulations provided herein use readily available materials. In some embodiments, provided are sustainable adhesive formulations with improved binding strength and/or quicker drying times relative to conventional adhesive formulations and/or improved water resistance relative to conventional adhesive formulations.

Provided herein are compositions and methods for adhering substrates. According to a first aspect, there is provided a formulation comprising: yeast; carboxylic acid; and solvent.

Provided herein also are compositions and methods for adhering substrates.

In one embodiment, a formulation comprising 15-50% (w/w dried yeast content), 10-60% carboxylic acid, 30-70% solvent (comprising water and organic solvent); wherein the solvent has a water content of 70-98% and an organic solvent content of 2-30% is provided.

In various embodiments, dry weight of yeast obtained from a slurry such as spent yeast obtained from a brewing process may be determined by any method as is well known in the art, for example dry weight and moisture content may be determined using a Kern moisture analyzer.

In one embodiment, a formulation comprising 15-50% (w/w dried yeast content), 10-60% carboxylic acid, 30-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 10-30% (w/w dried yeast content), 15-25% carboxylic acid, 55-75% solvent (comprising water and organic solvent); wherein the solvent has a water content of 70-98% and an organic solvent content of 2-30 is provided.

In one embodiment, a formulation comprising 10-30% (w/w dried yeast content), 15-25% carboxylic acid, 55-75% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 10-30% (w/w dried yeast content), 15-25% carboxylic acid, 55-75% solvent (comprising water and organic solvent); wherein the solvent has a water content of 90-98% and an organic solvent content of 3-10% is provided.

In one embodiment, a formulation comprising 10-30% (w/w dried yeast content), 15-25% carboxylic acid, 55-77% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 25-50% (w/w dried yeast content), 15-30% carboxylic acid, 30-60% solvent (comprising water and organic solvent); wherein the solvent has a water content of 70-98% and an organic solvent content of 2-30% is provided.

In one embodiment, a formulation comprising 25-50% (w/w dried yeast content), 15-30% carboxylic acid, 30-60% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 15-40% (w/w dried yeast content), 15-30% carboxylic acid 50-70% solvent (comprising water and organic solvent); wherein the solvent has a water content of 90-98% and an organic solvent content of 3-10% is provided.

In one embodiment, a formulation comprising 15-40% (w/w dried yeast content), 15-30% carboxylic acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 15-30% (w/w dried yeast content), 15-30% carboxylic acid, 50-70% solvent (comprising water and organic solvent); wherein the solvent has a water content of 90-98% and an organic solvent content of 3-10% is provided.

In one embodiment, a formulation comprising 15-30% (w/w dried yeast content), 15-30% carboxylic acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 15-30% (w/w dried yeast content), 15-30% carboxylic acid, 50-70% solvent (comprising water and organic solvent); wherein the solvent has a water content of 70-98% and an organic solvent content of 2-30% is provided.

In one embodiment, a formulation comprising 15-30% (w/w dried yeast content), 15-30% carboxylic acid, 50-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 30-50% (w/w dried yeast content), 10-30% carboxylic acid, 35-55% solvent (comprising water and organic solvent); wherein the solvent has a water content of 70-98% and an organic solvent content of 3-30% is provided.

In one embodiment, a formulation comprising 30-50% (w/w dried yeast content), 10-30% carboxylic acid, 35-55% solvent (comprising water and organic solvent); wherein the solvent has a water content of 70-98% and an organic solvent content of 3-00%; wherein the organic solvent is one or more selected from the group consisting of methanol, ethanol, n-propanol and isopropanol is provided.

In one embodiment, a formulation comprising 15-50% (w/w dried yeast content), 10-60% citric acid, 30-70% solvent (comprising water and organic solvent); wherein the solvent has a water content of 70-98% and an organic solvent content of 2-30% is provided.

In one embodiment, a formulation comprising 15-50% (w/w dried yeast content), 10-60% citric acid, 30-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 10-30% (w/w dried yeast content), 15-25% citric acid, 55-75% solvent (comprising water and organic solvent); wherein the solvent has a water content of 70-98% and an organic solvent content of 2-30% is provided.

In one embodiment, a formulation comprising 10-30% (w/w dried yeast content), 15-25% citric acid, 55-75% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 10-30% (w/w dried yeast content), 15-25% citric acid, 55-75% solvent (comprising water and organic solvent); wherein the solvent has a water content of 90-98% and an organic solvent content of 3-10% is provided.

In one embodiment, a formulation comprising 10-30% (w/w dried yeast content), 15-25% citric acid, 55-77% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 25-50% (w/w dried yeast content), 15-30% citric acid, 30-60% solvent (comprising water and organic solvent); wherein the solvent has a water content of 70-98% and an organic solvent content of 2-30 is provided.

In one embodiment, a formulation comprising 25-50% (w/w dried yeast content), 15-30% citric acid, 30-60% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 15-40% (w/w dried yeast content), 15-30% citric acid, 50-70% solvent (comprising water and organic solvent); wherein the solvent has a water content of 90-98% and an organic solvent content of 3-10% is provided.

In one embodiment, a formulation comprising 15-40% (w/w dried yeast content), 15-30% citric acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 15-30% (w/w dried yeast content), 15-30% citric acid, 50-70% solvent (comprising water and organic solvent); wherein the solvent has a water content of 90-98% and an organic solvent content of 3-10% is provided.

In one embodiment, a formulation comprising 15-30% (w/w dried yeast content), 15-30% citric acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 15-30% (w/w dried yeast content), 15-30% citric acid, 50-70% solvent (comprising water and organic solvent); wherein the solvent has a water content of 70-98% and an organic solvent content of 2-30% is provided.

In one embodiment, a formulation comprising 15-30% (w/w dried yeast content), 15-30% citric acid, 50-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 30-50% (w/w dried yeast content), 10-30% citric acid, 35-55% solvent (comprising water and organic solvent); wherein the solvent has a water content of 70-98% and an organic solvent content of 3-30% is provided.

In one embodiment, a formulation comprising 30-50% (w/w dried yeast content), 10-30% citric acid, 35-55% solvent (comprising water and organic solvent); wherein the solvent has a water content of 70-98% and an organic solvent content of 3-00%; wherein the organic solvent is one or more selected from the group consisting of methanol, ethanol, n-propanol and isopropanol is provided.

In one embodiment, a formulation comprising 15-50% (w/w dried yeast content), 10-60% gluten, 30-70% solvent (comprising water and organic solvent); wherein the solvent has a water content of 70-98% and an organic solvent content of 2-30% is provided.

In one embodiment, a formulation comprising 15-50% (w/w dried yeast content), 10-60% gluten, 30-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 10-30% (w/w dried yeast content), 15-25% gluten, 55-75% solvent (comprising water and organic solvent); wherein the solvent has a water content of 70-98% and an organic solvent content of 2-30% is provided.

In one embodiment, a formulation comprising 10-30% (w/w dried yeast content), 15-25% gluten, 55-75% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 10-30% (w/w dried yeast content), 15-25% gluten, 55-75% solvent (comprising water and organic solvent); wherein the solvent has a water content of 90-98% and an organic solvent content of 3-10% is provided.

In one embodiment, a formulation comprising 10-30% (w/w dried yeast content), 15-25% gluten, 55-77% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 25-50% (w/w dried yeast content), 15-30% gluten, 30-60% solvent (comprising water and organic solvent); wherein the solvent has a water content of 70-98% and an organic solvent content of 2-30%.

A formulation comprising 25-50% (w/w dried yeast content), 15-30% gluten, 30-60% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 15-40% (w/w dried yeast content), 15-30% gluten, 50-70% solvent (comprising water and organic solvent); wherein the solvent has a water content of 90-98% and an organic solvent content of 3-10% is provided.

In one embodiment, a formulation comprising 15-40% (w/w dried yeast content), 15-30% gluten, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 15-30% (w/w dried yeast content), 15-30% gluten, 50-70% solvent (comprising water and organic solvent); wherein the solvent has a water content of 90-98% and an organic solvent content of 3-10% is provided.

In one embodiment, a formulation comprising 15-30% (w/w dried yeast content), 15-30% gluten, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol is provided.

In one embodiment, a formulation comprising 15-30% (w/w dried yeast content), 15-30% gluten, 50-70% solvent (comprising water and organic solvent); wherein the solvent has a water content of 70-98% and an organic solvent content of 2-30% is provided.

In one embodiment, a formulation comprising, 15-30% gluten, 50-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol is provided.

In one embodiment, a formulation comprising 30-50% (w/w dried yeast content), 10-30% gluten, 35-55% solvent (comprising water and organic solvent); wherein the solvent has a water content of 70-98% and an organic solvent content of 3-30% is provided.

In one embodiment, a formulation comprising 30-50% (w/w dried yeast content), 10-30% gluten, 35-55% solvent (comprising water and organic solvent); wherein the solvent has a water content of 70-98% and an organic solvent content of 3-30%; wherein the organic solvent is one or more selected from the group consisting of methanol, ethanol, n-propanol and isopropanol is provided.

In one embodiment, a formulation comprising about 15.5% (w/w dried yeast content), about 19% citric acid, about 65.3% solvent (comprising water and organic solvent); wherein the solvent has a water content of about 94% and an organic solvent content of about 5.8%; wherein the organic solvent is one or more selected from the group consisting of methanol, ethanol, n-propanol and isopropanol is provided.

In one embodiment, a formulation comprising about 14.5% (w/w dried yeast content), about 18% citric acid, about 61% solvent (comprising water and organic solvent); wherein the solvent has a water content of about 94% and an organic solvent content of about 5.9%; wherein the organic solvent is one or more selected from the group consisting of methanol, ethanol, n-propanol and isopropanol is provided.

In one embodiment, a formulation comprising about 25.6% (w/w dried yeast content), about 19% citric acid, about 6.7% gluten, about 55.5% solvent (comprising water and organic solvent); wherein the solvent has a water content of about 89.5% and an organic solvent content of about 10.5%; wherein the organic solvent is one or more selected from the group consisting of methanol, ethanol, n-propanol and isopropanol is provided.

In one embodiment, a formulation comprising about 37.5% (w/w dried yeast content), about 27.5% citric acid, about 35% solvent (comprising water and organic solvent); wherein the solvent has a water content of about 89.6% and an organic solvent content of about 10.4%; wherein the organic solvent is one or more selected from the group consisting of methanol, ethanol, n-propanol and isopropanol is provided.

In one embodiment, a formulation comprising about 44.5% (w/w dried yeast content), about 11% citric acid, about 44.5% solvent (comprising water and organic solvent); wherein the solvent has a water content of about 87.4% and an organic solvent content of about 12.6%; wherein the organic solvent is one or more selected from the group consisting of methanol, ethanol, n-propanol and isopropanol is provided.

In one embodiment, a formulation comprising about 27% (w/w dried yeast content), about 20% citric acid, about 53% solvent (comprising water and organic solvent); wherein the solvent has a water content of about 72.5% and an organic solvent content of about 27.5%; wherein the organic solvent is one or more selected from the group consisting of methanol, ethanol, n-propanol and isopropanol is provided.

In one embodiment, a formulation comprising about 20.5% (w/w dried yeast content), about 15.2% citric acid, about 9.1% gluten, about 55% solvent (comprising water and organic solvent); wherein the solvent has a water content of about 72.5% and an organic solvent content of about 27.5%; wherein the organic solvent is one or more selected from the group consisting of methanol, ethanol, n-propanol and isopropanol is provided.

In an embodiment, the carboxylic acid has two or more carboxylic acid moieties or carboxylic acid derivative moieties.

In an embodiment, the solvent comprises water and an organic solvent selected from the group consisting of: methanol, ethanol, n-propanol and isopropanol and mixtures thereof.

In an embodiment, the carboxylic acid has two or more carboxylic acid moieties or carboxylic acid derivative moieties and the solvent comprises water and an organic solvent selected from the group consisting of: methanol, ethanol, n-propanol and isopropanol and mixtures thereof. Thus, there is provided in this embodiment a formulation comprising: yeast; carboxylic acid, wherein the carboxylic acid has two or more carboxylic acid moieties or carboxylic acid derivative moieties; and solvent, wherein the solvent comprises water and an organic solvent selected from the group consisting of: methanol, ethanol, n-propanol and isopropanol and mixtures thereof.

In certain embodiments, the term “carboxylic acid” as used herein refers to a molecule that is capable of forming chemical bonds (eg., covalent bonds) or relatively short sequences of chemical bonds to join two polymer chains together. In some embodiments a carboxylic acid of the disclosure is capable of cross-linking proteins/peptides, i.e., forming, or facilitating the formation of, chemical bonds (eg., covalent bonds) linking two proteins/peptides to each other. In certain embodiments the carboxylic acid forms chemical bonds between proteins present in the yeast component of a formulation as described herein. In some embodiments, the carboxylic acid of the formulations as provided herein do not crosslink polysaccharides.

In an embodiment, the carboxylic acid is a dicarboxylic acid or a tricarboxylic acid.

In an embodiment the carboxylic acid is one or more selected from the group consisting of oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid, itaconic acid, tartronic acid, mesaxalic acid, malic acid, tartaric acid, oxoloacetic acid, aspartic acid, α-hydroxy glutaric acid, glutamic acid, citric acid saccharic acid, gluten, alginic acid, caffeic acid, genipin, glutaraldehyde and tannic acid.

In an embodiment the carboxylic acid is one or more selected from the group consisting of oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid, itaconic acid, tartronic acid, mesaxalic acid, malic acid, tartaric acid, oxoloacetic acid, aspartic acid, α-hydroxy glutaric acid, glutamic acid, citric acid, saccharic acid, and alginic acid.

In an embodiment the carboxylic acid is one or more selected from the group consisting of oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid, itaconic acid, tartronic acid, mesaxalic acid, malic acid, tartaric acid, oxoloacetic acid, aspartic acid, α-hydroxy glutaric acid, glutamic acid, citric acid and saccharic acid.

In some embodiments, the carboxylic acid is not polyamidoamine epichlorohydrin (PAE). In some embodiments, the carboxylic acid is not formaldehyde. In some embodiments, the carboxylic acid is not glutaric aldehyde. In some embodiments, the carboxylic acid does not comprise an azetidinium group.

In some embodiments, the formulations, compositions or methods as described herein do not include or utilize polyamidoamine epichlorohydrin (PAE). In some embodiments, the formulations, compositions or methods as described herein do not include or utilize formaldehyde. In some embodiments, the formulations, compositions or methods as described herein do not include or utilize glutaric aldehyde. In some embodiments, the formulations, compositions or methods as described herein do not include or utilize any compound that includes an azetidinium group.

Unless indicated otherwise, percentages of ingredients of formulations provided herein are expressed as weight/weight (w/w) percentages (wt %).

In an embodiment, the carboxylic acid content present in the formulation is present in an amount of 1-90 wt %. In an embodiment, the carboxylic acid content present in the formulation is present in an amount of 1-85 wt %. In an embodiment, the carboxylic acid content present in the formulation is present in an amount of 1-80 wt %. In an embodiment, the carboxylic acid content present in the formulation is present in an amount of 1-75 wt %. In an embodiment, the carboxylic acid content present in the formulation is present in an amount of 1-70 wt %. In an embodiment, the carboxylic acid content present in the formulation is present in an amount of 1-65 wt %. In an embodiment, the carboxylic acid content present in the formulation is present in an amount of 1-60 wt %. In an embodiment, the carboxylic acid content present in the formulation is present in an amount of 1-55 wt %. In an embodiment, the carboxylic acid content present in the formulation is present in an amount of 1-50 wt %. In an embodiment, the carboxylic acid content present in the formulation is present in an amount of 1-45 wt %. In an embodiment, the carboxylic acid content present in the formulation is present in an amount of 1-40 wt %. In an embodiment, the carboxylic acid content present in the formulation is present in an amount of 1-35 wt %. In an embodiment, the carboxylic acid content present in the formulation is present in an amount of 1-30 wt %. In an embodiment, the carboxylic acid content present in the formulation is present in an amount of 5-90 wt %. In an embodiment, the carboxylic acid content present in the formulation is present in an amount of 5-85 wt %. In an embodiment, the carboxylic acid content present in the formulation is present in an amount of 5-80 wt %. In an embodiment, the carboxylic acid content present in the formulation is present in an amount of 5-75 wt %. In an embodiment, the carboxylic acid content present in the formulation is present in an amount of 5-70 wt %. In an embodiment, the carboxylic acid content present in the formulation is present in an amount of 5-65 wt %. In an embodiment, the carboxylic acid content present in the formulation is present in an amount of 5-60 wt %. In an embodiment, the carboxylic acid content present in the formulation is present in an amount of 5-55 wt %. In an embodiment, the carboxylic acid content present in the formulation is present in an amount of 5-50 wt %. In an embodiment, the carboxylic acid content present in the formulation is present in an amount of 5-45 wt %. In an embodiment, the carboxylic acid content present in the formulation is present in an amount of 5-40 wt %. In an embodiment, the carboxylic acid content present in the formulation is present in an amount of 5-35 wt %. In an embodiment, the carboxylic acid content present in the formulation is present in an amount of 5-30 wt %. In an embodiment, the carboxylic acid content present in the formulation is present in an amount of 10-90 wt %. In an embodiment, the carboxylic acid content present in the formulation is present in an amount of 10-85 wt %. In an embodiment, the carboxylic acid content present in the formulation is present in an amount of 10-80 wt %. In an embodiment, the carboxylic acid content present in the formulation is present in an amount of 10-75 wt %. In an embodiment, the carboxylic acid content present in the formulation is present in an amount of 10-70 wt %. In an embodiment, the carboxylic acid content present in the formulation is present in an amount of 10-65 wt %. In an embodiment, the carboxylic acid content present in the formulation is present in an amount of 10-60 wt %. In an embodiment, the carboxylic acid content present in the formulation is present in an amount of 10-55 wt %. In an embodiment, the carboxylic acid content present in the formulation is present in an amount of 10-50 wt %. In an embodiment, the carboxylic acid content present in the formulation is present in an amount of 10-45 wt %. In an embodiment, the carboxylic acid content present in the formulation is present in an amount of 10-40 wt %. In an embodiment, the carboxylic acid content present in the formulation is present in an amount of 10-35 wt %. In an embodiment, the carboxylic acid content present in the formulation is present in an amount of 10-30 wt %. In an embodiment, the carboxylic acid content present in the formulation is present in an amount of 10-20 wt %. In an embodiment, the carboxylic acid content present in the formulation is present in an amount of 10-15 wt %. In an embodiment, the carboxylic acid content present in the formulation is present in an amount of 15-50 wt %. In an embodiment, the carboxylic acid content present in the formulation is present in an amount of 15-40 wt %. In an embodiment, the carboxylic acid content present in the formulation is present in an amount of 15-35 wt %. In an embodiment, the carboxylic acid content present in the formulation is present in an amount of 15-30 wt %. In an embodiment, the carboxylic acid content present in the formulation is present in an amount of 15-25 wt %. In an embodiment, the carboxylic acid content present in the formulation is present in an amount of about 5 wt %. In an embodiment, the carboxylic acid content present in the formulation is present in an amount of about 5 wt %. In an embodiment, the carboxylic acid content present in the formulation is present in an amount of about 10 wt %. In an embodiment, the carboxylic acid content present in the formulation is present in an amount of about 15 wt %. In an embodiment, the carboxylic acid content present in the formulation is present in an amount of about 20 wt %. In an embodiment, the carboxylic acid content present in the formulation is present in an amount of about 25 wt %. In an embodiment, the carboxylic acid content present in the formulation is present in an amount of about 30 wt %. In an embodiment, the carboxylic acid content present in the formulation is present in an amount of about 35 wt %. In an embodiment, the carboxylic acid content present in the formulation is present in an amount of about 40 wt %. In an embodiment, the carboxylic acid content present in the formulation is present in an amount of about 45 wt %. In an embodiment, the carboxylic acid content present in the formulation is present in an amount of about 50 wt %. In an embodiment, the carboxylic acid content present in the formulation is present in an amount of about 55 wt %.

In an embodiment, the dried yeast content present in the formulation is present in an amount of 1-90 wt %. In an embodiment, the dried yeast content present in the formulation is present in an amount of 1-85 wt %. In an embodiment, the dried yeast content present in the formulation is present in an amount of 1-80 wt %. In an embodiment, the dried yeast content present in the formulation is present in an amount of 1-75 wt %. In an embodiment, the dried yeast content present in the formulation is present in an amount of 1-70 wt %. In an embodiment, the dried yeast content present in the formulation is present in an amount of 1-65 wt %. In an embodiment, the dried yeast content present in the formulation is present in an amount of 1-60 wt %. In an embodiment, the dried yeast content present in the formulation is present in an amount of 1-55 wt %. In an embodiment, the dried yeast content present in the formulation is present in an amount of 1-50 wt %. In an embodiment, the dried yeast content present in the formulation is present in an amount of 5-90 wt %. In an embodiment, the dried yeast content present in the formulation is present in an amount of 5-85 wt %. In an embodiment, the dried yeast content present in the formulation is present in an amount of 5-80 wt %. In an embodiment, the dried yeast content present in the formulation is present in an amount of 5-75 wt %. In an embodiment, the dried yeast content present in the formulation is present in an amount of 5-70 wt %. In an embodiment, the dried yeast content present in the formulation is present in an amount of 5-65 wt %. In an embodiment, the dried yeast content present in the formulation is present in an amount of 5-60 wt %. In an embodiment, the dried yeast content present in the formulation is present in an amount of 5-55 wt %. In an embodiment, the dried yeast content present in the formulation is present in an amount of 5-50 wt %. In an embodiment, the dried yeast content present in the formulation is present in an amount of 10-90 wt %. In an embodiment, the dried yeast content present in the formulation is present in an amount of 10-85 wt %. In an embodiment, the dried yeast content present in the formulation is present in an amount of 10-80 wt %. In an embodiment, the dried yeast content present in the formulation is present in an amount of 10-75 wt %. In an embodiment, the dried yeast content present in the formulation is present in an amount of 10-70 wt %. In an embodiment, the dried yeast content present in the formulation is present in an amount of 10-65 wt %. In an embodiment, the dried yeast content present in the formulation is present in an amount of 10-60 wt %. In an embodiment, the dried yeast content present in the formulation is present in an amount of 10-55 wt %. In an embodiment, the dried yeast content present in the formulation is present in an amount of 10-50 wt %. In an embodiment, the dried yeast content present in the formulation is present in an amount of 5-80 wt %. In an embodiment, the dried yeast content present in the formulation is present in an amount of 5-60 wt %. In an embodiment, the dried yeast content present in the formulation is present in an amount of 10-30 wt %. In an embodiment, the dried yeast content present in the formulation is present in an amount of 10-45 wt %. In an embodiment, the dried yeast content present in the formulation is present in an amount of 15-50 wt %. In an embodiment, the dried yeast content present in the formulation is present in an amount of 15-45 wt %. In an embodiment, the dried yeast content present in the formulation is present in an amount of 15-30 wt %. In an embodiment, the dried yeast content present in the formulation is present in an amount of 20-45 wt %. In an embodiment, the dried yeast content present in the formulation is present in an amount of 10-20 wt %. In an embodiment, the dried yeast content present in the formulation is present in an amount of 20-25 wt %. In an embodiment, the dried yeast content present in the formulation is present in an amount of 25-30 wt %. In an embodiment, the dried yeast content present in the formulation is present in an amount of 30-35 wt %. In an embodiment, the dried yeast content present in the formulation is present in an amount of 35-40 wt %. In an embodiment, the dried yeast content present in the formulation is present in an amount of 40-45 wt %. In an embodiment, the dried yeast content present in the formulation is present in an amount of 45-50 wt %. In an embodiment, the dried yeast content present in the formulation is present in an amount of 50-55 wt %.

In an embodiment, the dried yeast content present in the formulation is present in an amount of about 10 wt %. In an embodiment, the dried yeast content present in the formulation is present in an amount of about 10 wt %. In an embodiment, the dried yeast content present in the formulation is present in an amount of about 15 wt %. In an embodiment, the dried yeast content present in the formulation is present in an amount of about 20 wt %. In an embodiment, the dried yeast content present in the formulation is present in an amount of about 25 wt %. In an embodiment, the dried yeast content present in the formulation is present in an amount of about 30 wt %. In an embodiment, the dried yeast content present in the formulation is present in an amount of about 35 wt %. In an embodiment, the dried yeast content present in the formulation is present in an amount of about 40 wt %. In an embodiment, the dried yeast content present in the formulation is present in an amount of about 45 wt %. In an embodiment, the dried yeast content present in the formulation is present in an amount of about 50 wt %. In an embodiment, the dried yeast content present in the formulation is present in an amount of about 55 wt %.

As used herein, the term “dried yeast content” means the w/w % that yeast would make up in a formulation if the solvent or liquid is removed, or substantially removed.

In an embodiment, the solvent (comprising water and an organic solvent) present in the formulation is present in an amount of 10-90 wt %. In an embodiment, the solvent content present in the formulation is present in an amount of 10-85 wt %. In an embodiment, the solvent content present in the formulation is present in an amount of 10-80 wt %. In an embodiment, the solvent content present in the formulation is present in an amount of 10-75 wt %. In an embodiment, the solvent content present in the formulation is present in an amount of 10-70 wt %. In an embodiment, the solvent content present in the formulation is present in an amount of 15-90 wt %. In an embodiment, the solvent content present in the formulation is present in an amount of 15-85 wt %. In an embodiment, the solvent content present in the formulation is present in an amount of 15-80 wt %. In an embodiment, the solvent content present in the formulation is present in an amount of 15-75 wt %. In an embodiment, the solvent content present in the formulation is present in an amount of 15-70 wt %. In an embodiment, the solvent content present in the formulation is present in an amount of 20-90 wt %. In an embodiment, the solvent content present in the formulation is present in an amount of 20-85 wt %. In an embodiment, the solvent content present in the formulation is present in an amount of 20-80 wt %. In an embodiment, the solvent content present in the formulation is present in an amount of 20-75 wt %. In an embodiment, the solvent content present in the formulation is present in an amount of 20-70 wt %. In an embodiment, the solvent content present in the formulation is present in an amount of 25-90 wt %. In an embodiment, the solvent content present in the formulation is present in an amount of 25-85 wt %. In an embodiment, the solvent content present in the formulation is present in an amount of 25-80 wt %. In an embodiment, the solvent content present in the formulation is present in an amount of 25-75 wt %. In an embodiment, the solvent content present in the formulation is present in an amount of 25-70 wt %. In an embodiment, the solvent content present in the formulation is present in an amount of 30-90 wt %. In an embodiment, the solvent content present in the formulation is present in an amount of 30-85 wt %. In an embodiment, the solvent content present in the formulation is present in an amount of 30-80 wt %. In an embodiment, the solvent content present in the formulation is present in an amount of 30-75 wt %. In an embodiment, the solvent content present in the formulation is present in an amount of 30-70 wt %. In an embodiment, the solvent content present in the formulation is present in an amount of 35-70 wt %. In an embodiment, the solvent content present in the formulation is present in an amount of 40-70 wt %. In an embodiment, the solvent content present in the formulation is present in an amount of 45-70 wt %. In an embodiment, the solvent content present in the formulation is present in an amount of 50-70 wt %. In an embodiment, the solvent content present in the formulation is present in an amount of 40-70 wt %. In an embodiment, the solvent content present in the formulation is present in an amount of 40-65 wt %.

In an embodiment, the solvent content present in the formulation is present in an amount of 40-55 wt %. In an embodiment, the solvent content present in the formulation is present in an amount of about 40% wt %. In an embodiment, the solvent content present in the formulation is present in an amount of about 45% wt %. In an embodiment, the solvent content present in the formulation is present in an amount of about 50% wt %. In an embodiment, the solvent content present in the formulation is present in an amount of about 55% wt %. In an embodiment, the solvent content present in the formulation is present in an amount of about 60% wt %. In an embodiment, the solvent content present in the formulation is present in an amount of about 65% wt %. In an embodiment, the solvent content present in the formulation is present in an amount of about 70% wt %.

In an embodiment, the solvent has a water content of 10 wt %-99 wt %. In an embodiment, the solvent has a water content of 20 wt %-99 wt %. In an embodiment, the solvent has a water content of 30 wt %-99 wt %. In an embodiment, the solvent has a water content of 40 wt %-99 wt %. In an embodiment, the solvent has a water content of 50 wt %-99 wt %. In an embodiment, the solvent has a water content of 60 wt %-99 wt %. In an embodiment, the solvent has a water content of 65 wt %-99 wt %. In an embodiment, the solvent has a water content of 10 wt %-95 wt %. In an embodiment, the solvent has a water content of 20 wt %-95 wt %. In an embodiment, the solvent has a water content of 30 wt %-95 wt %. In an embodiment, the solvent has a water content of 40 wt %-95 wt %. In an embodiment, the solvent has a water content of 50 wt %-95 wt %. In an embodiment, the solvent has a water content of 60 wt %-95 wt %. In an embodiment, the solvent has a water content of 65 wt %-95 wt %.

In an embodiment, the solvent has an organic solvent content of 1 wt %-90 wt %. In an embodiment, the solvent has an organic solvent content of 1 wt %-80 wt %. In an embodiment, the solvent has an organic solvent content of 1 wt %-70 wt %. In an embodiment, the solvent has an organic solvent content of 1 wt %-60 wt %. In an embodiment, the solvent has an organic solvent content of 1 wt %-50 wt %. In an embodiment, the solvent has an organic solvent content of 1 wt %-40 wt %. In an embodiment, the solvent has an organic solvent content of 1 wt %-35 wt %. In an embodiment, the solvent has an organic solvent content of 5 wt %-90 wt %. In an embodiment, the solvent has an organic solvent content of 5 wt %-80 wt %. In an embodiment, the solvent has an organic solvent content of 5 wt %-70 wt %. In an embodiment, the solvent has an organic solvent content of 5 wt %-60 wt %. In an embodiment, the solvent has an organic solvent content of 5 wt %-50 wt %. In an embodiment, the solvent has an organic solvent content of 5 wt %-40 wt %. In an embodiment, the solvent has an organic solvent content of 5 wt %-35 wt %.

In an embodiment, the solvent has a water content of 60 wt %-99 wt % and the solvent has an organic solvent content of 1 wt %-40 wt %. In an embodiment, the solvent has a water content of 65 wt %-99 wt % and the solvent has an organic solvent content of 1 wt %-35 wt %. In an embodiment, the solvent has a water content of 60 wt %-95 wt % and the solvent has an organic solvent content of 5 wt %-40 wt %. In an embodiment, the solvent has a water content of 65 wt %-95 wt % and the solvent has an organic solvent content of 5 wt %-35 wt %.

In some embodiments, the formulation does not include any added starch, for example any added purified or isolated starch, e.g., in some embodiments, starch present in the formulation may derived only from the yeast component of the formulation. In some embodiments, the formulation does not include any added dextran, for example any added purified or isolated dextran, e.g., in some embodiments, starch present in the formulation may derived only from the yeast component of the formulation.

In some existing adhesives (such as those described in WO2020104811A1) the use of specific alkaline and acid treatments gives rise to adhesive characteristics. Often, or generally, such require the use of a strong acid and strong base to achieve the adhesiveness, and/or the ability of the cross-linking agents to cross-link (such as to cross-link proteins as described herein). Also, such alkaline/acid based adhesives often, or generally, require a neutralization of the strong base with the addition of a strong acid, or vice-versa. The alkaline and acid treatments are used to break down the yeast cell walls. Re-linking of hydrolysed material from the yeast cells then occurs under substantially neutral conditions. Treatment with both base and acid is mandatory in such formulations because as explained, for example in WO2020104811 A1, using only acid treatment or only base treatment results in a formulation that ‘cannot usefully be used as a binder’. In some embodiments of the formulations and methods of the instant disclosure such alkaline and acid treatments are not necessary. In certain embodiments of the formulations and methods of the instant disclosure there is no neutralization of a strong base or strong acid. Many acid/base adhesives such as described in WO2020104811A1 use acids such as hydrochloric acid and bases such as sodium hydroxide. Sodium hydroxide and hydrochloric acid are both known to be corrosive substances and can be considered ‘harsh’ chemicals to handle. Accordingly, in some embodiments of the compositions and methods of the instant disclosure do not involve Sodium hydroxide, hydrochloric acid or similar corrosive chemicals.

According to an additional embodiment, there is provided a use of a formulation of the disclosure as an adhesive.

In certain embodiments a formulation of the disclosure may be used to create a solid composition. For example, the formulation may bind sawdust and/or wood chips to make a particle board composition, or to bind sheets of wood to make plywood. In an embodiment, the sawdust and/or wood chips and/or sheets of wood are selected from the group consisting of pine, birch and oak sawdust and/or wood chips and/or sheets of wood. In some embodiments a formulation as described herein may be used to create a solid formulation for various uses, for example a solid formulation with an active ingredient that can be used for pest control such as compositions for controlling snail and/or slug infestations.

In some embodiments a formulation or composition as described herein may include a preservative, for example to extend the shelf life of the composition. In some embodiments, the preservative is one or more selected from the group consisting of Benzisothiazolinone, Methylisothiazolinone, DMDM Hydantoin, lodopropynyl Butylcarbamate, Phenoxyethanol, Quaternium-15, Sodium benzoate, Potassium sorbate, Sodium metabisulfite, Ethylparaben, Propylparaben, Methylparaben, Butylparaben, Benzoic acid, and Sorbic acid.

According one aspect, there is provided a method of joining a first and second item comprising:
(a) contacting at least the first item with the adhesive formulation of the disclosure to prepare a formulation-coated first item;
(b) contacting the second item with the adhesive formulation-coated first item to prepare a joined item;
(d) allowing the adhesive formulation to cure thereby joining the first and second item.

In an embodiment, after step (b) and before step (d) there is the additional step of applying heat and/or pressure to the joined item of step (b).

According to another aspect, there is provided a method of making an adhesive formulation of the disclosure comprising:
combining: (1) dried yeast; (2) carboxylic acid; and (3) solvent;
mixing the combination of (1), (2) and (3) to produce the adhesive formulation;
or
combining: (1) a mixture of dried yeast and dried carboxylic acid; and (2) solvent;
mixing the combination of (1) and (2) to produce the adhesive formulation.

In some embodiments, the formulations and methods disclosed herein are used for adhesives in cardboard, plywood and/or manufactured wood products. Within the cardboard and manufactured wood industry, binders and adhesive formulations are typically made on site. Binder precursors are purchased and mixed prior to use. If the process were to use an acid/base shock adhesive system (such as the WO2020104811A1 systems that involve sodium hydroxide and hydrochloric acid), this may have health and safety implications as staff would have to be trained in the handling of corrosive substances and appropriate personal protective equipment and infrastructure would be required on-site for mixing hazardous precursors which can be expensive. Therefore, there is a need in the field to find safer reagents in the field of adhesive formulations to reduce any associated risk in the handling of reagents during the adhesive formulation manufacturing process; a need that certain aspects and embodiments of the instant disclosure can address.

According to another aspect, there is provided a particle board or ply board wood product obtainable from a process comprising contacting an adhesive formulation of the disclosure with sawdust and/or wood chips and/or sheets of wood and allowing the adhesive formulation to cure thereby joining the sawdust and/or wood chips and/or sheets of wood. In an embodiment, the sawdust and/or wood chips and/or sheets of wood are selected from the group consisting of pine, birch and oak sawdust and/or wood chips and/or sheets of wood.

According to another aspect, there is provided a cardboard and/or paper product obtainable from a process comprising contacting an adhesive formulation of the disclosure with a first cardboard and/or paper component and a second cardboard and/or paper component and allowing the adhesive formulation to cure thereby joining the first and second cardboard and/or paper components.

### DETAILED DESCRIPTION

In certain aspects and embodiments of the present disclosure, compositions and methods are made as described herein.

### Yeast

Yeast is used on a vast scale in both brewing and baking, meaning spent yeast is readily available and cheap.

In an embodiment, yeast is virgin yeast or is yeast derived from a waste source.

In an embodiment, the yeast is selected from wild yeasts, such as Pichia, Kloeckera, and Torulopsis.

In another embodiment the yeast is of the Saccharomyces genus or Candida genus or a mixture thereof. Suitably the yeast may be brewer's yeast, spent brewer's yeast, baker's yeast or low-grade, animal-feed yeast. Baker's yeast may be sourced from Lallemand (Fermipan); low-grade yeast may be sourced from Cangzhou Xindewei Animal Drug Co.; and spent brewer's yeast may be sourced from the brewing process. The brewer's yeast, spent brewer's yeast and baker's yeast may be Saccharomyces cerevisiae yeast. Yeast that is typically used in animal feed typically contains about 40-60% by weight of a mixture of Candida and Saccharomyces yeast, and other components such as ashes.

In an embodiment, yeast is virgin yeast or is yeast derived from a waste source. In one embodiment the yeast is derived from waste from a brewing process or other bioreactor process.

Production of beer produces large amounts of by-product waste products (see Rachwa #K, Wasko A, Gustaw K, Polak-Berecka M. Utilization of brewery wastes in food industry. PeerJ. 2020 Jul. 14; 8:e9427. doi: 10.7717/peerj.9427. PMID: 32742775; PMCID: PMC7367049). There are three main types of by-products: (1) brewers spent grain (BSG), (2) hops/hot trub; and (3) residual brewer's yeast (BSY). The residual brewer's yeast from the beer making process is a slurry residue that accounts for up to 15% of the total beer making brewing process. Disposal of the spent yeast can incur increased costs to the brewery as well as create environmental concerns as if not disposed properly can create odor problems and/or contaminate soil and water bodies. Other sources of spent yeast that can be environmentally problematic and/or costly in manufacturing include spent yeast from wine making (sometimes referred to as “lees”), spent yeast from production of distilled spirits (sometimes referred to as stillage), spent yeast from biofuel production, and the like. Accordingly, in various embodiments of the compositions, formulations, and methods, the yeast used is derived from a yeast-waste product such as described herein.

The yeast may be in a dry powdered form or may be a by-product of the brewing process or other yeast-bioreactor process. In dry powdered form, yeast has a typical water content of around 4% by weight, such as 2-8 wt %, whereas spent brewer's yeast has a typical water content of 10-90 wt %.

In various embodiments, yeast is added to a formulation of the disclosure as dry powdered yeast. In other embodiments the yeast is added as a slurry or solution, for example a solution or slurry that is made by adding dried yeast to a solvent such as water or a solution or slurry that is obtained from a liquid containing yeast (such as, for example, spent yeast from a brewing process).

In the case of spent brewer's yeast, before the yeast is used to make the binder its water content may be decreased. This may suitably be achieved using air drying, oven drying, or a centrifuge. In many embodiments, drying (decreasing the moisture and/or water content) of a yeast slurry is achieved by centrifugation (spinning down the solid components of a yeast slurry and removing supernatant, thus reducing the solvent content). The use of a centrifuge at, for example, 1000-5000 (e.g. about 3000) revolutions per minute, or at centrifugal force of from 8000 g to 12000 g, for a period of time from 1 to 30 minutes (e.g. about 10 minutes) may be suitable. The use of high temperatures, such as above 40° C., may in certain situations and embodiments denature and/or destroy useful cell wall biomolecules. Therefore, in some embodiments the drying is achieved at 40° C. or below, e.g. at about room temperature (20-25° C.). The moisture content (and in turn yeast dry weight) for yeast samples can be determined as described herein (for example, using a Kern moisture analyzer).

In certain embodiments, such as, for example, embodiments where spent yeast (such as spent yeast from a brewing process) is used, the yeast sample may be washed to remove contaminants. Such washing may be done using a filter and running liquid (e.g., water and/or organic solvent) over the yeast and through the filter and subsequently collecting the solid yeast portion from the filter. In related embodiments the yeast sample may be washed

### Carboxylic Acid

In an embodiment, the carboxylic acid is a dicarboxylic acid or a tricarboxylic acid. The carboxylic acid moieties of the dicarboxylic acid or tricarboxylic acid carboxylic acids may be derivatised. The carboxylic acid may further include one or more moieties selected from the group consisting of: ester moieties, amide moieties, hydroxyl moieties and aldehyde moieties in addition to the two/three carboxylic acid moieties.

In an embodiment, the carboxylic acid is a tricarboxylic acid. The carboxylic acid moieties of the tricarboxylic acid carboxylic acids may be derivatised. For example, the carboxylic acid may be citric acid. Advantageously, citric acid is a naturally occurring material, is not corrosive and therefore requires no special handling, is fully biodegradable and can be sustainably sourced.

In an alternative embodiment, the carboxylic acid is a dicarboxylic acid. The carboxylic acid moieties of the dicarboxylic acid carboxylic acids may be derivatised. For example, the carboxylic acid may be selected from the group consisting of: oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid and itaconic acid, tartronic acid, mesaxalic acid, malic acid, tartaric acid, oxoloacetic acid, aspartic acid, α-hydroxy glutaric acid, glutamic acid and saccharic acid.

The term “carboxylic acid derivative moiety” includes ester and amide equivalents of the carboxylic acid parent moiety. For example, —C(O)OR, wherein R is an C1-4 alkyl group, are included in the term “carboxylic acid derivative moiety”. Likewise, —C(O)NRR′, wherein R and R′ are each independently selected from H and an C1-4 alkyl group, are included in the term “carboxylic acid derivative moiety”.

### Additional Component

In an embodiment, the formulation further comprises an additional component. For example, the additional component might have two or more independently selected moieties selected from the group consisting of: carboxylic acid moieties, ester moieties, amide moieties, hydroxyl moieties and aldehyde moieties. The additional component may be selected from the group consisting of: gluten, alginic acid, caffeic acid, genipin, glutaraldehyde and tannic acid. The additional component may be gluten. Advantageously, gluten is a naturally occurring material, is not corrosive and therefore requires no special handling, is fully biodegradable and can be sustainably sourced.

In an embodiment, when present, the additional component is present in an amount of 1-20 wt %. In an embodiment, the additional component content present in the formulation is present in an amount of 1-15 wt %. In an embodiment, the additional component content present in the formulation is present in an amount of 1-10 wt %. In an embodiment, when present, the additional component is present in an amount of 5-20 wt %. In an embodiment, the additional component content present in the formulation is present in an amount of 5-15 wt %. In an embodiment, the additional component content present in the formulation is present in an amount of 5-10 wt %.

In an embodiment, the additional component is an additional carboxylic acid component, and the formulation further comprises the additional carboxylic acid component. For example, the additional carboxylic acid might have two or more independently selected moieties selected from the group consisting of: carboxylic acid moieties, ester moieties, amide moieties, hydroxyl moieties and aldehyde moieties. The additional carboxylic acid may be selected from the group consisting of: gluten, alginic acid, caffeic acid, genipin, glutaraldehyde and tannic acid. The additional carboxylic acid may be gluten. Advantageously, gluten is a naturally occurring material, is not corrosive and therefore requires no special handling, is fully biodegradable and can be sustainably sourced.

In an embodiment, when present, the additional carboxylic acid is present in an amount of 1-20 wt %. In an embodiment, the additional carboxylic acid content present in the formulation is present in an amount of 1-15 wt %. In an embodiment, the additional carboxylic acid content present in the formulation is present in an amount of 1-10 wt %. In an embodiment, when present, the additional carboxylic acid is present in an amount of 5-20 wt %. In an embodiment, the additional carboxylic acid content present in the formulation is present in an amount of 5-15 wt %. In an embodiment, the additional carboxylic acid content present in the formulation is present in an amount of 5-10 wt %.

### Salt Component

In an embodiment, the formulation further comprises a salt component. The purpose of the salt component is to disrupt the yeast cell wall and allow the constituent components of the yeast cell to be released into the adhesive composition more readily. A high concentration of these salts can create an osmotic stress that help weaken the yeast cell wall. Certain salts, like LiOAc or CaCl₂) can improve cell wall permeability. Therefore, the salt component accelerates the process of production of the adhesive composition.

In an embodiment, the salt component is selected from the group consisting of: NaCl, KCl, CaCl₂, MgSO₄, NaOAc, (NH₄)₂SO₄ and LiOAC. In an embodiment, the salt component is NaCl.

In an embodiment, when present, the salt component is present in an amount of 0.01-2 wt %. In an embodiment, the salt component content present in the formulation is present in an amount of 0.01-1.5 wt %. In an embodiment, the salt component content present in the formulation is present in an amount of 0.01-1 wt %. In an embodiment, the salt component content present in the formulation is present in an amount of 0.01-0.9 wt %. In an embodiment, the salt component content present in the formulation is present in an amount of 0.01-0.8 wt %. In an embodiment, the salt component content present in the formulation is present in an amount of 0.01-0.7 wt %.

In an embodiment, when present, the salt component is present in an amount of 0.05-2 wt %. In an embodiment, the salt component content present in the formulation is present in an amount of 0.1-2 wt %. In an embodiment, the salt component content present in the formulation is present in an amount of 0.2-2 wt %. In an embodiment, the salt component content present in the formulation is present in an amount of 0.3-2 wt %. In an embodiment, the salt component content present in the formulation is present in an amount of 0.4-2 wt %. In an embodiment, the salt component content present in the formulation is present in an amount of 0.5-2 wt %.

In an embodiment, when present, the salt component is present in an amount of 0.05-1.5 wt %. In an embodiment, when present, the salt component is present in an amount of 0.1-1.45 wt %. In an embodiment, when present, the salt component is present in an amount of 0.15-1.4 wt %. In an embodiment, when present, the salt component is present in an amount of 0.2-1.35 wt %. In an embodiment, when present, the salt component is present in an amount of 0.25-1.3 wt %. In an embodiment, the salt component content present in the formulation is present in an amount of 0.3-1.25 wt %. In an embodiment, the salt component content present in the formulation is present in an amount of 0.35-1.2 wt %. In an embodiment, the salt component content present in the formulation is present in an amount of 0.4-1.15 wt %. In an embodiment, the salt component content present in the formulation is present in an amount of 0.45-1.1 wt %. In an embodiment, the salt component content present in the formulation is present in an amount of 0.5-1.05 wt %.

In an embodiment, the salt component content present in the formulation is present in an amount of 0.5-1 wt %.

### Solvent

In an embodiment, the solvent comprises water and/or organic solvent. Preferably the solvent comprises water and an organic solvent. At least a portion of the water content may originate from the source of yeast. By using an organic solvent, the amount of water used in the formulation can be reduced, which can reduce the drying time of the formulation if organic solvents having a boiling point lower than water are used. The organic solvent present in the solvent system may form an azeotropic mixture with the water which will assist in the removal of water from the formulation.

The organic solvent may be selected from the group consisting of: acetone, butanone, methanol, ethanol, propanol (e.g. n-propanol or isopropanol), diethyl ether, methyl acetate, ethyl acetate, toluene, 1,4-dioxane, tetrahydrofuran, acetonitrile, methylene chloride, γ-valerolactone, cyrene, and 2-MeTHF, and mixtures thereof. In one embodiment the organic solvent is selected from methanol, ethanol, propanol (e.g. n-propanol or isopropanol), γ-valerolactone, cyrene, and 2-MeTHF and mixtures thereof, which can be sustainably sourced. In one embodiment the solvent is selected from methanol, ethanol, and propanol (e.g. n-propanol or isopropanol) and mixtures thereof. In one embodiment the solvent is ethanol.

The organic solvent may be selected from the group consisting of: acetone, butanone, methanol, ethanol, propanol, diethyl ether, methyl acetate, ethyl acetate, toluene, 1,4-dioxane, tetrahydrofuran, acetonitrile, methylene chloride, γ-valerolactone, cyrene, and 2-MeTHF, and mixtures thereof. In one embodiment the organic solvent is selected from methanol, ethanol, propanol, γ-valerolactone, cyrene, and 2-MeTHF and mixtures thereof, which can be sustainably sourced. In one embodiment the solvent is selected from methanol, ethanol, and propanol and mixtures thereof. In one embodiment the solvent is ethanol.

In an embodiment, the formulation has a pH of between 4.5-6.5, preferably 5-6.

In an embodiment, the formulation further comprising a colourant. A colourant as used herein is anything that can be added to a formulation as provided herein to change or alter the color of the formulation. In some embodiments the colourant comprises one or more pigments, which are solid color particles available in various forms and colors. In certain embodiment the colorant comprises one or more dyes, which are soluble colorants providing vibrant shades. In some embodiments the colourant may include one or more of titanium dioxide (a white pigment used for lighter shades and improved opacity), carbon black (a black pigment for dark-colored glues), iron oxides (which can come in red, yellow, and brown for earth-toned colors), chromium oxide green, and ultramarines provide blue and violet shades. In an embodiment, the colourant is a metal oxide material, for example, a ferric material.

In some embodiments, a formulation as described herein includes a perfume. A perfume as used herein refers to anything that can be added to alter or mask the aroma of the formulation. In an embodiment, the perfume is a volatile oil.

### Wood Adhesive Bonding Strength Evaluation Methods

To establish a material's mechanical properties according to the BS EN 312:2010 code, the following tests may be conducted.

| Property | Code | Test method |
|---|---|---|
| Modulus of elasticity in bending | EN 310 | Three point bending test |

The modulus of elasticity in bending and bending strength are determined by applying a load to the centre of a test piece supported at two points. The modulus of elasticity is calculated by using the slope of the linear region of the load-deflection curve; the value calculated is the apparent modulus, not the true modulus, because the test method includes shear as well as bending.

| Property | Code | Test method |
|---|---|---|
| Bending strength | EN 310 | Three point bending test |

The bending strength of each test piece is calculated by determining the ratio of the bending moment AT, at the maximum load Fmax, to the moment of its full cross section.

| Property | Code | Test method |
|---|---|---|
| Internal bond | EN 319 | Perpendicular tensile strength test |

Determination of resistance to tension perpendicular to the surface of the test piece by submitting the latter to a uniformly distributed tensile force until rupture occurs. Tensile strength perpendicular to the plane of the board is determined by the maximum load in relation to the surface area of the test piece.

| Property | Code | Test method |
|---|---|---|
| Standard Test Method for Strength | ASTM | Shear by Compression |
| Properties of Adhesive Bonds | D905-03 | Loading |

This test method covers the determination of the comparative shear strengths of adhesive bonds used for bonding wood and other similar materials, when tested on a standard specimen under specified conditions of preparation, conditioning, and loading in compression. This test method is intended primarily as an evaluation of adhesives for wood.

Interpretation of bonding strength of wood adhesives are carried out based on where the failure or separation occurred in the mechanical tests. This includes cohesive failure of the adhesive, adhesive failure at the interface, mixed failure-a combination of those two and wood cohesive failure.

### Water Resistance can be Determined Based on ASTM Standard Methods D1183-96.

Adhesive penetration depth has a close relationship with the ultimate performance of wood composites. An excessive penetration causes an increase in manufacturing cost and defects on the bond line. In contrast, insufficient penetration leads to a reduction in bonding strength due to limited contact areas for formation of chemical/mechanical bonding.

### Specific Exemplary Examples

In addition to the aspects and embodiments provided elsewhere herein, the following list of exemplary embodiments are specifically contemplated:
1. A formulation comprising: yeast, a carboxylic acid, and solvent.
2. A formulation comprising: yeast, a carboxylic acid, and solvent; wherein said carboxylic acid has two or more carboxylic acid moieties or carboxylic acid derivative moieties.
3. A formulation comprising: yeast, a carboxylic acid, and solvent; wherein said carboxylic acid is a dicarboxylic acid or a tricarboxylic acid.
4. A formulation comprising: yeast, a carboxylic acid, and solvent; wherein said carboxylic acid is a dicarboxylic acid.
5. A formulation comprising: yeast, a carboxylic acid, and solvent; wherein said carboxylic acid is a tricarboxylic acid.
6. A formulation comprising: yeast, a carboxylic acid, and solvent; wherein said carboxylic acid includes one or more moieties selected from the group consisting of: ester moieties, amide moieties, hydroxyl moieties and aldehyde moieties.
7. A formulation comprising: yeast, a carboxylic acid, and solvent; wherein the carboxylic acid is selected from the group consisting of: oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid, itaconic acid, tartronic acid, mesaxalic acid, malic acid, tartaric acid, oxoloacetic acid, aspartic acid, α-hydroxy glutaric acid, glutamic acid, citric acid, saccharic acid, gluten, alginic acid, caffeic acid, genipin, glutaraldehyde and tannic acid.
8. A formulation comprising: yeast, a carboxylic acid, and solvent; wherein the carboxylic acid is selected from the group consisting of: oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid, itaconic acid, tartronic acid, mesaxalic acid, malic acid, tartaric acid, oxoloacetic acid, aspartic acid, α-hydroxy glutaric acid, glutamic acid, citric acid and saccharic acid.
9. A formulation comprising: yeast, a carboxylic acid, and solvent; wherein said carboxylic acid is oxalic acid.
10. A formulation comprising: yeast, a carboxylic acid, and solvent; wherein said carboxylic acid is malonic acid.
11. A formulation comprising: yeast, a carboxylic acid, and solvent; wherein said carboxylic acid is succinic acid.
12. A formulation comprising: yeast, a carboxylic acid, and solvent; wherein said carboxylic acid is glutaric acid.
13. A formulation comprising: yeast, a carboxylic acid, and solvent; wherein said carboxylic acid is adipic acid.
14. A formulation comprising: yeast, a carboxylic acid, and solvent; wherein said carboxylic acid is pimelic acid.
15. A formulation comprising: yeast, a carboxylic acid, and solvent; wherein said carboxylic acid is suberic acid.
16. A formulation comprising: yeast, a carboxylic acid, and solvent; wherein said carboxylic acid is azelaic acid.
17. A formulation comprising: yeast, a carboxylic acid, and solvent; wherein said carboxylic acid is sebacic acid.
18. A formulation comprising: yeast, a carboxylic acid, and solvent; wherein said carboxylic acid is maleic acid.
19. A formulation comprising: yeast, a carboxylic acid, and solvent; wherein said carboxylic acid is fumaric acid.
20. A formulation comprising: yeast, a carboxylic acid, and solvent; wherein said carboxylic acid is glutaconic acid.
21. A formulation comprising: yeast, a carboxylic acid, and solvent; wherein said carboxylic acid is traumatic acid.
22. A formulation comprising: yeast, a carboxylic acid, and solvent; wherein said carboxylic acid is muconic acid.
23. A formulation comprising: yeast, a carboxylic acid, and solvent; wherein said carboxylic acid is glutinic acid.
24. A formulation comprising: yeast, a carboxylic acid, and solvent; wherein said carboxylic acid is citraconic acid.
25. A formulation comprising: yeast, a carboxylic acid, and solvent; wherein said carboxylic acid is mesaconic acid.
26. A formulation comprising: yeast, a carboxylic acid, and solvent; wherein said carboxylic acid is itaconic acid.
27. A formulation comprising: yeast, a carboxylic acid, and solvent; wherein said carboxylic acid is tartronic acid.
28. A formulation comprising: yeast, a carboxylic acid, and solvent; wherein said carboxylic acid is mesaxalic acid.
29. A formulation comprising: yeast, a carboxylic acid, and solvent; wherein said carboxylic acid is malic acid.
30. A formulation comprising: yeast, a carboxylic acid, and solvent; wherein said carboxylic acid is tartaric acid.
31. A formulation comprising: yeast, a carboxylic acid, and solvent; wherein said carboxylic acid is oxoloacetic acid.
32. A formulation comprising: yeast, a carboxylic acid, and solvent; wherein said carboxylic acid is aspartic acid.
33. A formulation comprising: yeast, a carboxylic acid, and solvent; wherein said carboxylic acid is α-hydroxy glutaric acid.
34. A formulation comprising: yeast, a carboxylic acid, and solvent; wherein said carboxylic acid is glutamic acid.
35. A formulation comprising: yeast, a carboxylic acid, and solvent; wherein said carboxylic acid is citric acid.
36. A formulation comprising: yeast, a carboxylic acid, and solvent; wherein said carboxylic acid is saccharic acid.
37. A formulation comprising: yeast, a carboxylic acid, and solvent; wherein said carboxylic acid is gluten.
38. A formulation comprising: yeast, a carboxylic acid, and solvent; wherein said carboxylic acid is alginic acid.
39. A formulation comprising: yeast, a carboxylic acid, and solvent; wherein said carboxylic acid is caffeic acid.
40. A formulation comprising: yeast, a carboxylic acid, and solvent; wherein said carboxylic acid is genipin.
41. A formulation comprising: yeast, a carboxylic acid, and solvent; wherein said carboxylic acid is glutaraldehyde.
42. A formulation comprising: yeast, a carboxylic acid, and solvent; wherein said carboxylic acid is tannic acid.
43. A formulation comprising: yeast, a carboxylic acid, and solvent; wherein the solvent comprises water.
44. A formulation comprising: yeast, a carboxylic acid, and solvent; wherein the solvent comprises an organic solvent selected from the group consisting of: methanol, ethanol and propanol (e.g. n-propanol or isopropanol) and mixtures thereof.
45. A formulation comprising: yeast, a carboxylic acid, and solvent; wherein the solvent comprises water and an organic solvent selected from the group consisting of: methanol, ethanol and propanol (e.g. n-propanol or isopropanol) and mixtures thereof.
46. A formulation comprising:
   a. yeast;
   b. carboxylic acid, wherein the carboxylic acid has two or more carboxylic acid moieties or carboxylic acid derivative moieties; and
   c. solvent, wherein the solvent comprises water.
47. A formulation comprising:
   a. yeast;
   b. carboxylic acid, wherein the carboxylic acid has two or more carboxylic acid moieties or carboxylic acid derivative moieties; and
   c. solvent, wherein the solvent comprises an organic solvent selected from the group consisting of: methanol, ethanol and propanol (e.g. n-propanol or isopropanol) and mixtures thereof.
48. A formulation comprising:
   a. yeast;
   b. carboxylic acid, wherein the carboxylic acid has two or more carboxylic acid moieties or carboxylic acid derivative moieties; and solvent, wherein the solvent comprises water and an organic solvent selected from the group consisting of: methanol, ethanol and propanol (e.g. n-propanol or isopropanol) and mixtures thereof.
49. A formulation comprising 15-50% (w/w dried yeast content), 10-60% carboxylic acid, 30-70% solvent (comprising water and organic solvent); wherein the solvent has a water content of 70-98% and an organic solvent content of 2-30%.
50. A formulation comprising 15-50% (w/w dried yeast content), 10-60% carboxylic acid, 30-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
51. A formulation comprising 10-30% (w/w dried yeast content), 15-25% carboxylic acid, 55-75% solvent (comprising water and organic solvent); wherein the solvent has a water content of 70-98% and an organic solvent content of 2-30%.
52. A formulation comprising 10-30% (w/w dried yeast content), 15-25% carboxylic acid, 55-75% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
53. A formulation comprising 10-30% (w/w dried yeast content), 15-25% carboxylic acid, 55-75% solvent (comprising water and organic solvent); wherein the solvent has a water content of 90-98% and an organic solvent content of 3-10%.
54. A formulation comprising 10-30% (w/w dried yeast content), 15-25% carboxylic acid, 55-77% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
55. A formulation comprising 25-50% (w/w dried yeast content), 15-30% carboxylic acid, 30-60% solvent (comprising water and organic solvent); wherein the solvent has a water content of 70-98% and an organic solvent content of 2-30%.
56. A formulation comprising 25-50% (w/w dried yeast content), 15-30% carboxylic acid, 30-60% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
57. A formulation comprising 15-40% (w/w dried yeast content), 15-30% carboxylic acid 50-70% solvent (comprising water and organic solvent); wherein the solvent has a water content of 90-98% and an organic solvent content of 3-10%.
58. A formulation comprising 15-40% (w/w dried yeast content), 15-30% carboxylic acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
59. A formulation comprising 15-30% (w/w dried yeast content), 15-30% carboxylic acid, 50-70% solvent (comprising water and organic solvent); wherein the solvent has a water content of 90-98% and an organic solvent content of 3-10%.
60. A formulation comprising 15-30% (w/w dried yeast content), 15-30% carboxylic acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
61. A formulation comprising 15-30% (w/w dried yeast content), 15-30% carboxylic acid, 50-70% solvent (comprising water and organic solvent); wherein the solvent has a water content of 70-98% and an organic solvent content of 2-30%.
62. A formulation comprising 15-30% (w/w dried yeast content), 15-30% carboxylic acid, 50-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
63. A formulation comprising 30-50% (w/w dried yeast content), 10-30% carboxylic acid, 35-55% solvent (comprising water and organic solvent); wherein the solvent has a water content of 70-98% and an organic solvent content of 3-30%.
64. A formulation comprising 30-50% (w/w dried yeast content), 10-30% carboxylic acid, 35-55% solvent (comprising water and organic solvent); wherein the solvent has a water content of 70-98% and an organic solvent content of 3-00%; wherein the organic solvent is one or more selected from the group consisting of methanol, ethanol, n-propanol and isopropanol.
65. The formulation of any one of the preceding embodiments, wherein the carboxylic acid is a dicarboxylic acid or a tricarboxylic acid.
66. The formulation of any one of the preceding embodiments, wherein the carboxylic acid is a tricarboxylic acid.
67. The formulation of any one of the preceding embodiments, wherein the carboxylic acid is citric acid.
68. The formulation of any one of the preceding embodiments, wherein the carboxylic acid is a dicarboxylic acid.
69. The formulation of any one of the preceding embodiments, wherein the carboxylic acid is selected from the group consisting of: oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid and itaconic acid, tartronic acid, mesaxalic acid, malic acid, tartaric acid, oxoloacetic acid, aspartic acid, α-hydroxy glutaric acid, glutamic acid and saccharic acid.
70. The formulation of any one of the preceding embodiments, wherein the carboxylic acid further includes one or more moieties selected from the group consisting of: ester moieties, amide moieties, hydroxyl moieties and aldehyde moieties.
71. The formulation of any one of the preceding embodiments, wherein the formulation includes a first carboxylic acid and a second carboxylic acid.
72. The formulation of any one of the preceding embodiments, wherein the formulation includes a first carboxylic acid and a second carboxylic acid, further wherein the second carboxylic acid has two or more independently selected moieties selected from the group consisting of: carboxylic acid moieties, ester moieties, amide moieties, hydroxyl moieties and aldehyde moieties.
73. The formulation of any one of the preceding embodiments, wherein the formulation includes a first carboxylic acid and a second carboxylic acid, further wherein the second carboxylic acid is gluten.
74. The formulation of any one of the preceding embodiments, wherein the yeast is present in the formulation in an amount of 1-90% (w/w dried yeast content).
75. The formulation of any one of the preceding embodiments, wherein the yeast is present in the formulation in an amount of 5-80% (w/w dried yeast content).
76. The formulation of any one of the preceding embodiments, wherein the yeast is present in the formulation in an amount of 5-60% (w/w dried yeast content).
77. The formulation of any one of the preceding embodiments, wherein the yeast is present in the formulation in an amount of 10-50% (w/w dried yeast content).
78. The formulation of any one of the preceding embodiments, wherein the yeast is present in the formulation in an amount of 10-30% (w/w dried yeast content).
79. The formulation of any one of the preceding embodiments, wherein the yeast is present in the formulation in an amount of 10-45% (w/w dried yeast content).
80. The formulation of any one of the preceding embodiments, wherein the yeast is present in the formulation in an amount of 15-50%% (w/w dried yeast content).
81. The formulation of any one of the preceding embodiments, wherein the yeast is present in the formulation in an amount of 15-45% (w/w dried yeast content).
82. The formulation of any one of the preceding embodiments, wherein the yeast is present in the formulation in an amount of 15-30% (w/w dried yeast content).
83. The formulation of any one of the preceding embodiments, wherein the yeast is present in the formulation in an amount of 20-45% (w/w dried yeast content).
84. The formulation of any one of the preceding embodiments, wherein the yeast is present in the formulation in an amount of about 10% (w/w dried yeast content).
85. The formulation of any one of the preceding embodiments, wherein the yeast is present in the formulation in an amount of about 15% (w/w dried yeast content).
86. The formulation of any one of the preceding embodiments, wherein the yeast is present in the formulation in an amount of about 20% (w/w dried yeast content).
87. The formulation of any one of the preceding embodiments, wherein the yeast is present in the formulation in an amount of about 25% (w/w dried yeast content).
88. The formulation of any one of the preceding embodiments, wherein the yeast is present in the formulation in an amount of about 30% (w/w dried yeast content).
89. The formulation of any one of the preceding embodiments, wherein the yeast is present in the formulation in an amount of about 35% (w/w dried yeast content).
90. The formulation of any one of the preceding embodiments, wherein the yeast is present in the formulation in an amount of about 40% (w/w dried yeast content).
91. The formulation of any one of the preceding embodiments, wherein the yeast is present in the formulation in an amount of about 45% (w/w dried yeast content).
92. The formulation of any one of the preceding embodiments, wherein the yeast is present in the formulation in an amount of about 50% (w/w dried yeast content).
93. The formulation of any one of the preceding embodiments, wherein the yeast is present in the formulation in an amount of about 55% (w/w dried yeast content).
94. The formulation of any one of the preceding embodiments, wherein the carboxylic acid is present in the formulation in an amount of 1-90% (w/w).
95. The formulation of any one of the preceding embodiments, wherein the carboxylic acid is present in the formulation in an amount of 5-90% (w/w).
96. The formulation of any one of the preceding embodiments, wherein the carboxylic acid is present in the formulation in an amount of 5-75% (w/w).
97. The formulation of any one of the preceding embodiments, wherein the carboxylic acid is present in the formulation in an amount of 5-60% (w/w).
98. The formulation of any one of the preceding embodiments, wherein the carboxylic acid is present in the formulation in an amount of 5-55% (w/w).
99. The formulation of any one of the preceding embodiments, wherein the carboxylic acid is present in the formulation in an amount of 5-50% (w/w).
100. The formulation of any one of the preceding embodiments, wherein the carboxylic acid is present in the formulation in an amount of 5-45% (w/w).
101. The formulation of any one of the preceding embodiments, wherein the carboxylic acid is present in the formulation in an amount of 5-40% (w/w).
102. The formulation of any one of the preceding embodiments, wherein the carboxylic acid is present in the formulation in an amount of 5-35% (w/w).
103. The formulation of any one of the preceding embodiments, wherein the carboxylic acid is present in the formulation in an amount of 5-30% (w/w).
104. The formulation of any one of the preceding embodiments, wherein the carboxylic acid is present in the formulation in an amount of 5-20% (w/w).
105. The formulation of any one of the preceding embodiments, wherein the carboxylic acid is present in the formulation in an amount of 5-15% (w/w).
106. The formulation of any one of the preceding embodiments, wherein the carboxylic acid is present in the formulation in an amount of 10-90% (w/w).
107. The formulation of any one of the preceding embodiments, wherein the carboxylic acid is present in the formulation in an amount of 10-75% (w/w).
108. The formulation of any one of the preceding embodiments, wherein the carboxylic acid is present in the formulation in an amount of 10-60% (w/w).
109. The formulation of any one of the preceding embodiments, wherein the carboxylic acid is present in the formulation in an amount of 10-55% (w/w).
110. The formulation of any one of the preceding embodiments, wherein the carboxylic acid is present in the formulation in an amount of 10-50% (w/w).
111. The formulation of any one of the preceding embodiments, wherein the carboxylic acid is present in the formulation in an amount of 10-45% (w/w).
112. The formulation of any one of the preceding embodiments, wherein the carboxylic acid is present in the formulation in an amount of 10-40% (w/w).
113. The formulation of any one of the preceding embodiments, wherein the carboxylic acid is present in the formulation in an amount of 10-35% (w/w).
114. The formulation of any one of the preceding embodiments, wherein the carboxylic acid is present in the formulation in an amount of 10-30% (w/w).
115. The formulation of any one of the preceding embodiments, wherein the carboxylic acid is present in the formulation in an amount of 10-25% (w/w).
116. The formulation of any one of the preceding embodiments, wherein the carboxylic acid is present in the formulation in an amount of 10-20% (w/w).
117. The formulation of any one of the preceding embodiments, wherein the carboxylic acid is present in the formulation in an amount of 10-15% (w/w).
118. The formulation of any one of the preceding embodiments, wherein the carboxylic acid is present in the formulation in an amount of 15-50% (w/w).
119. The formulation of any one of the preceding embodiments, wherein the carboxylic acid is present in the formulation in an amount of 15-40% (w/w).
120. The formulation of any one of the preceding embodiments, wherein the carboxylic acid is present in the formulation in an amount of 15-35% (w/w).
121. The formulation of any one of the preceding embodiments, wherein the carboxylic acid is present in the formulation in an amount of 15-30% (w/w).
122. The formulation of any one of the preceding embodiments, wherein the carboxylic acid is present in the formulation in an amount of 15-25% (w/w).
123. The formulation of any one of the preceding embodiments, wherein the carboxylic acid is present in the formulation in an amount of about 5% (w/w).
124. The formulation of any one of the preceding embodiments, wherein the carboxylic acid is present in the formulation in an amount of about 10% (w/w).
125. The formulation of any one of the preceding embodiments, wherein the carboxylic acid is present in the formulation in an amount of about 15% (w/w).
126. The formulation of any one of the preceding embodiments, wherein the carboxylic acid is present in the formulation in an amount of about 20% (w/w).
127. The formulation of any one of the preceding embodiments, wherein the carboxylic acid is present in the formulation in an amount of about 25% (w/w).
128. The formulation of any one of the preceding embodiments, wherein the carboxylic acid is present in the formulation in an amount of about 30% (w/w).
129. The formulation of any one of the preceding embodiments, wherein the carboxylic acid is present in the formulation in an amount of about 35% (w/w).
130. The formulation of any one of the preceding embodiments, wherein the carboxylic acid is present in the formulation in an amount of about 40% (w/w).
131. The formulation of any one of the preceding embodiments, wherein the carboxylic acid is present in the formulation in an amount of about 45% (w/w).
132. The formulation of any one of the preceding embodiments, wherein the carboxylic acid is present in the formulation in an amount of about 50% (w/w).
133. The formulation of any one of the preceding embodiments, wherein the carboxylic acid is present in the formulation in an amount of about 55% (w/w).
134. The formulation of any one of the preceding embodiments, wherein the solvent (comprising water and organic solvent) is present in the formulation in an amount of 30-70% (w/w).
135. The formulation of any one of the preceding embodiments, wherein the solvent (comprising water and organic solvent) is present in the formulation in an amount of 30-70% (w/w).
136. The formulation of any one of the preceding embodiments, wherein the solvent (comprising water and organic solvent) is present in the formulation in an amount of 30-65% (w/w).
137. The formulation of any one of the preceding embodiments, wherein the solvent (comprising water and organic solvent) is present in the formulation in an amount of 35-70% (w/w).
138. The formulation of any one of the preceding embodiments, wherein the solvent (comprising water and organic solvent) is present in the formulation in an amount of 35-65% (w/w).
139. The formulation of any one of the preceding embodiments, wherein the solvent (comprising water and organic solvent) is present in the formulation in an amount of 35-60% (w/w).
140. The formulation of any one of the preceding embodiments, wherein the solvent (comprising water and organic solvent) is present in the formulation in an amount of 40-70% (w/w).
141. The formulation of any one of the preceding embodiments, wherein the solvent (comprising water and organic solvent) is present in the formulation in an amount of 40-65% (w/w).
142. The formulation of any one of the preceding embodiments, wherein the solvent (comprising water and organic solvent) is present in the formulation in an amount of 40-60% (w/w).
143. The formulation of any one of the preceding embodiments, wherein the solvent (comprising water and organic solvent) is present in the formulation in an amount of 50-70% (w/w).
144. The formulation of any one of the preceding embodiments, wherein the solvent (comprising water and organic solvent) is present in the formulation in an amount of 50-65% (w/w).
145. The formulation of any one of the preceding embodiments, wherein the solvent (comprising water and organic solvent) is present in the formulation in an amount of about 30% (w/w).
146. The formulation of any one of the preceding embodiments, wherein the solvent (comprising water and organic solvent) is present in the formulation in an amount of about 35% (w/w).
147. The formulation of any one of the preceding embodiments, wherein the solvent (comprising water and organic solvent) is present in the formulation in an amount of about 40% (w/w).
148. The formulation of any one of the preceding embodiments, wherein the solvent (comprising water and organic solvent) is present in the formulation in an amount of about 45% (w/w).
149. The formulation of any one of the preceding embodiments, wherein the solvent (comprising water and organic solvent) is present in the formulation in an amount of about 50% (w/w).
150. The formulation of any one of the preceding embodiments, wherein the solvent (comprising water and organic solvent) is present in the formulation in an amount of about 55% (w/w).
151. The formulation of any one of the preceding embodiments, wherein the solvent (comprising water and organic solvent) is present in the formulation in an amount of about 60% (w/w).
152. The formulation of any one of the preceding embodiments, wherein the solvent (comprising water and organic solvent) is present in the formulation in an amount of about 65% (w/w).
153. The formulation of any one of the preceding embodiments, wherein the solvent (comprising water and organic solvent) is present in the formulation in an amount of about 70% (w/w).
   The formulation of any one of the preceding embodiments, wherein the solvent (comprising water and organic solvent) is present in the formulation in an amount of about 75% (w/w).
154. A formulation comprising 15-50% (w/w dried yeast content), 10-60% citric acid, 30-70% solvent (comprising water and organic solvent); wherein the solvent has a water content of 70-98% and an organic solvent content of 2-30%.
155. A formulation comprising 15-50% (w/w dried yeast content), 10-60% citric acid, 30-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
156. A formulation comprising 10-30% (w/w dried yeast content), 15-25% citric acid, 55-75% solvent (comprising water and organic solvent); wherein the solvent has a water content of 70-98% and an organic solvent content of 2-30%.
157. A formulation comprising 10-30% (w/w dried yeast content), 15-25% citric acid, 55-75% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
158. A formulation comprising 10-30% (w/w dried yeast content), 15-25% citric acid, 55-75% solvent (comprising water and organic solvent); wherein the solvent has a water content of 90-98% and an organic solvent content of 3-10%.
159. A formulation comprising 10-30% (w/w dried yeast content), 15-25% citric acid, 55-77% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
160. A formulation comprising 25-50% (w/w dried yeast content), 15-30% citric acid, 30-60% solvent (comprising water and organic solvent); wherein the solvent has a water content of 70-98% and an organic solvent content of 2-30%.
161. A formulation comprising 25-50% (w/w dried yeast content), 15-30% citric acid, 30-60% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
162. A formulation comprising 15-40% (w/w dried yeast content), 15-30% citric acid, 50-70% solvent (comprising water and organic solvent); wherein the solvent has a water content of 90-98% and an organic solvent content of 3-10%.
163. A formulation comprising 15-40% (w/w dried yeast content), 15-30% citric acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
164. A formulation comprising 15-30% (w/w dried yeast content), 15-30% citric acid, 50-70% solvent (comprising water and organic solvent); wherein the solvent has a water content of 90-98% and an organic solvent content of 3-10%.
165. A formulation comprising 15-30% (w/w dried yeast content), 15-30% citric acid, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
166. A formulation comprising 15-30% (w/w dried yeast content), 15-30% citric acid, 50-70% solvent (comprising water and organic solvent); wherein the solvent has a water content of 70-98% and an organic solvent content of 2-30%.
167. A formulation comprising 15-30% (w/w dried yeast content), 15-30% citric acid, 50-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
168. A formulation comprising 30-50% (w/w dried yeast content), 10-30% citric acid, 35-55% solvent (comprising water and organic solvent); wherein the solvent has a water content of 70-98% and an organic solvent content of 3-30%.
169. A formulation comprising 30-50% (w/w dried yeast content), 10-30% citric acid, 35-55% solvent (comprising water and organic solvent); wherein the solvent has a water content of 70-98% and an organic solvent content of 3-00%; wherein the organic solvent is one or more selected from the group consisting of methanol, ethanol, n-propanol and isopropanol.
170. A formulation comprising 15-50% (w/w dried yeast content), 10-60% gluten, 30-70% solvent (comprising water and organic solvent); wherein the solvent has a water content of 70-98% and an organic solvent content of 2-30%.
171. A formulation comprising 15-50% (w/w dried yeast content), 10-60% gluten, 30-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
172. A formulation comprising 10-30% (w/w dried yeast content), 15-25% gluten, 55-75% solvent (comprising water and organic solvent); wherein the solvent has a water content of 70-98% and an organic solvent content of 2-30%.
173. A formulation comprising 10-30% (w/w dried yeast content), 15-25% gluten, 55-75% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
174. A formulation comprising 10-30% (w/w dried yeast content), 15-25% gluten, 55-75% solvent (comprising water and organic solvent); wherein the solvent has a water content of 90-98% and an organic solvent content of 3-10%.
175. A formulation comprising 10-30% (w/w dried yeast content), 15-25% gluten, 55-77% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
176. A formulation comprising 25-50% (w/w dried yeast content), 15-30% gluten, 30-60% solvent (comprising water and organic solvent); wherein the solvent has a water content of 70-98% and an organic solvent content of 2-30%.
177. A formulation comprising 25-50% (w/w dried yeast content), 15-30% gluten, 30-60% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
178. A formulation comprising 15-40% (w/w dried yeast content), 15-30% gluten, 50-70% solvent (comprising water and organic solvent); wherein the solvent has a water content of 90-98% and an organic solvent content of 3-10%.
179. A formulation comprising 15-40% (w/w dried yeast content), 15-30% gluten, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
180. A formulation comprising 15-30% (w/w dried yeast content), 15-30% gluten, 50-70% solvent (comprising water and organic solvent); wherein the solvent has a water content of 90-98% and an organic solvent content of 3-10%.
181. A formulation comprising 15-30% (w/w dried yeast content), 15-30% gluten, 50-70% solvent (comprising water and organic solvent); wherein the solvent has a water content of 90-98% and an organic solvent content of 3-10%; wherein the organic solvent is one or more selected from the group consisting of methanol, ethanol, n-propanol and isopropanol.
182. A formulation comprising 15-30% (w/w dried yeast content), 15-30% gluten, 50-70% solvent (comprising water and organic solvent); wherein the solvent has a water content of 70-98% and an organic solvent content of 2-30%.
183. A formulation comprising 15-30% (w/w dried yeast content), 15-30% gluten, 50-70% solvent (comprising water and organic solvent); wherein the solvent has a water content of 70-98% and an organic solvent content of 2-30%; wherein the organic solvent is one or more selected from the group consisting of methanol, ethanol, n-propanol and isopropanol.
184. A formulation comprising 30-50% (w/w dried yeast content), 10-30% gluten, 35-55% solvent (comprising water and organic solvent); wherein the solvent has a water content of 70-98% and an organic solvent content of 3-30%.
185. A formulation comprising 30-50% (w/w dried yeast content), 10-30% gluten, about 35-55% solvent (comprising water and organic solvent); wherein the solvent has a water content of 70-98% and an organic solvent content of 3-30%; wherein the organic solvent is one or more selected from the group consisting of methanol, ethanol, n-propanol and isopropanol.
186. A formulation comprising about 15.5% (w/w dried yeast content), about 19% citric acid, about 65.3% solvent (comprising water and organic solvent); wherein the solvent has a water content of about 94% and an organic solvent content of about 5.8%; wherein the organic solvent is one or more selected from the group consisting of methanol, ethanol, n-propanol and isopropanol.
187. A formulation comprising about 14.5% (w/w dried yeast content), about 18% citric acid, about 61% solvent (comprising water and organic solvent); wherein the solvent has a water content of about 94% and an organic solvent content of about 5.9%; wherein the organic solvent is one or more selected from the group consisting of methanol, ethanol, n-propanol and isopropanol.
188. A formulation comprising about 25.6% (w/w dried yeast content), about 19% citric acid, about 6.7% gluten, about 55.5% solvent (comprising water and organic solvent); wherein the solvent has a water content of about 89.5% and an organic solvent content of about 10.5%; wherein the organic solvent is one or more selected from the group consisting of methanol, ethanol, n-propanol and isopropanol.
189. A formulation comprising about 37.5% (w/w dried yeast content), about 27.5% citric acid, about 35% solvent (comprising water and organic solvent); wherein the solvent has a water content of about 89.6% and an organic solvent content of about 10.4%; wherein the organic solvent is one or more selected from the group consisting of methanol, ethanol, n-propanol and isopropanol.
190. A formulation comprising about 44.5% (w/w dried yeast content), about 11% citric acid, about 44.5% solvent (comprising water and organic solvent); wherein the solvent has a water content of about 87.4% and an organic solvent content of about 12.6%; wherein the organic solvent is one or more selected from the group consisting of methanol, ethanol, n-propanol and isopropanol.
191. A formulation comprising about 27% (w/w dried yeast content), about 20% citric acid, about 53% solvent (comprising water and organic solvent); wherein the solvent has a water content of about 72.5% and an organic solvent content of about 27.5%; wherein the organic solvent is one or more selected from the group consisting of methanol, ethanol, n-propanol and isopropanol.
192. A formulation comprising about 20.5% (w/w dried yeast content), about 15.2% citric acid, about 9.1% gluten, about 55% solvent (comprising water and organic solvent); wherein the solvent has a water content of about 72.5% and an organic solvent content of about 27.5%; wherein the organic solvent is one or more selected from the group consisting of methanol, ethanol, n-propanol and isopropanol.
193. The formulation of any one of the preceding embodiments, wherein the formulation further comprises a preservative.
194. The formulation of any one of the preceding embodiments, wherein the formulation further comprises a preservative selected from the group consisting of Benzisothiazolinone, Methylisothiazolinone, DMDM Hydantoin, lodopropynyl Butylcarbamate, Phenoxyethanol, Quaternium-15, Sodium benzoate, Potassium sorbate, Sodium metabisulfite, Ethylparaben, Propylparaben, Methylparaben, Butylparaben, Benzoic acid, and Sorbic acid.
195. The formulation of any one of the preceding embodiments, wherein the yeast is virgin yeast or is yeast derived from a waste source.
196. The formulation of any one of the preceding embodiments wherein the yeast is spent yeast from a beer brewing process.
197. The formulation of any one of the preceding embodiments, further comprising a colourant
198. The formulation of any one of the preceding embodiments, further comprising a perfume.
199. The formulation of any one of the preceding embodiments, wherein the pH of the formulation is between 5-6.
200. A composition comprising a substrate and a formulation of any one of the preceding embodiments.
201. Use of a formulation of any one of the preceding embodiments as an adhesive.
202. A particle board composition comprising wood shavings adhered with a formulation of any one of the preceding embodiments.
203. A particle board composition comprising sawdust adhered with a formulation of any one of the preceding embodiments.
204. A method of joining a first and second item comprising:
   a. contacting at least the first item with the formulation of any one of the preceding embodiments, to prepare a formulation-coated first item;
   b. contacting the second item with the formulation-coated first item to prepare a joined item;
   c. optionally applying heat and/or pressure to the joined item of step b;
   d. allowing the formulation to cure thereby joining the first and second item.
205. Method of making a formulation of any one of the preceding embodiments, comprising:
   a. combining: (1) dried yeast; (2) carboxylic acid, wherein the carboxylic acid has two or more carboxylic acid moieties; and (3) solvent, wherein the solvent comprises water and an organic solvent selected from the group consisting of: methanol, ethanol and propanol (e.g. n-propanol or isopropanol) and mixtures thereof;
   b. mixing the combination of (1), (2) and (3) to produce the formulation;
      or
   a. combining: (1) a mixture of dried yeast and dried carboxylic acid, wherein the carboxylic acid has two or more carboxylic acid moieties; and (2) solvent, wherein the solvent comprises water and an organic solvent selected from the group consisting of: methanol, ethanol and propanol (e.g. n-propanol or isopropanol) and mixtures thereof;
   b. mixing the combination of (1) and (2) to produce the formulation.

### EXAMPLES

The present disclosure will be further described in the following examples, which do not limit the scope of the present disclosure. In addition to the aspects and embodiments provided elsewhere herein, the following list of exemplary embodiments are specifically contemplated:

### Example 1: Purification of Spent Yeast

500 g samples of purified yeast were prepared using the following method. The purified yeast obtained was then used to make the adhesive formulations described in Example 2.
Weigh 1 g of a spent yeast slurry from a beer brewing process and add to a 50 ml centrifuge tube.
Add 10 ml of ethanol diluted with deionised water to reach a final concentration of 10 wt. % or 20 wt. % ethanol prior to use.
Mix for 10 minutes using a magnetic stirrer.
As a wash step, centrifuge the yeast solution using a high-speed centrifuge (Thermo Scientific™ Sorvall LYNX 6000® Superspeed Centrifuge) at 4000×g (RCF), for 5 minutes at 4° C.
Remove the supernatant and add deionised water to the tube, mix well and centrifuge as above to remove any remaining alcohol.
The dry weight of yeast in the samples (and moisture content) are determined using a Kern moisture analyzer.
Purified yeast samples are ready for use.

### Example 2: Synthesis of Yeast-Based Binder

Yeast slurry samples (500 g) collected as waste from beer brewing are purified as explained in Example 1. The resulting pellet is weighed and moisture content (and, in turn, yeast dry weight) is determined using a Kern moisture analyzer to determine the amount of actual yeast. Ethanol and citric acid and optionally gluten and optionally additional water are added to bring total amounts as desired (for example amounts specified in Table 1 below). The formula is stirred at 70 degrees C. for 10 min to solubilize the components.

### Example 3: Formulations

In the below table, dried yeast is expressed as the dry weight of yeast as determined using methods provided herein, and total moisture content refers to total solvent amounts (water plus organic solvent). Each of the formulations are made consistent with the procedures explained in Examples 1 and 2. Water from yeast is the amount of water in the yeast sample remaining as measured using the Kern analyzer. Extra water is that water added beyond what is already present in the yeast sample.

TABLE 1

| | | Water | | | | | Total |
|---|---|---|---|---|---|---|---|
| | Dried | from | Extra | Citric | | | moisture |
| Name | Yeast | Yeast | water | acid | Ethanol | Gluten | content |
| G1 | 1.6 g | 6.4 g | — | 2 g | 0.4 g | — | |
| % | 15.4 | 61.5 | — | 19.2 | 3.8 | — | 65.3 |
| G2 | 0.89 g | 3.58 g | — | 1.12 g | 0.22 g | 0.42 g | |
| % | 14.3 | 57.4 | — | 17.9 | 3.6 | 6.7 | 61 |
| G3 | 4.42 g | 8.58 g | — | 3.25 g | 1 g | — | |
| % | 25.6 | 49.7 | — | 18.8 | 5.8 | — | 55.5 |
| G3a | 4.42 g | 3.7 g | — | 3.25 g | 0.43 g | — | |
| % | 37.5 | 31.4 | — | 27.5 | 3.65 | — | 35.05 |
| G6d | 8 g | — | 7 g | 2 g | 1 g | — | |
| % | 44.4 | — | 38.9 | 11.1 | 5.6 | — | 44.5 |
| G6 | 2.72 g | 5.28 g | — | 2 g | 2 g | — | |
| % | 22.7 | 44 | — | 16.7 | 16.7 | — | 60.7 |
| G6a | 2.72 g | 3.86 g | — | 2 g | 1.46 g | — | |
| % | 27.1 | 38.4 | — | 19.9 | 14.6 | — | 53 |
| G6g | 1.13 g | 2.2 g | — | 0.83 g | 0.83 g | 0.5 g | |
| % | 20.6 | 40 | — | 15.2 | 15.2 | 9.1 | 55.2 |
| PO | 1.6 g | 6.4 g | — | — | — | — | |
| % | 20 | 80 | — | — | — | — | 80 |
| VY | 3.4 g | 6.6 g | — | — | — | — | |
| % | 34 | 66 | — | — | — | — | 66 |
| VYD | 10 g | — | — | — | — | — | |
| % | 100 | — | — | — | — | — | 0 |

### Example 4: Formulation Binding Strength

Each formulation was coated onto a first wooden block before placing a second wooden block on top. The blocks were then hot pressed together at 200 bar, 135 degrees C. for 5 min using an 8000 kg (8-ton) 600W−6 cm×12 cm roisen press.

The adhesion strength is given below in the table:

| Name | Adhesion Strength |
|---|---|
| G1 | Strong bonding |
| G2 | Strong bonding |
| G3 | Strong bonding |
| G3a | Strong bonding |
| G6d | Strong bonding |
| G6 | Strong bonding |
| G6a | Strong bonding |
| G6g | Strong bonding |
| PO | Medium bonding |
| VY | Medium bonding |
| VYD | No bonding |

The above adhesion strength experiment was repeated and tested using European Ash in a MultiTest-I Single-column force tester up to 5 kN with U-form Double-action Vice Grip MEC240 g including jaws and ILC-S 5000N Loadcell. The surface area in which glue was applied prior to pressing covered an area of 15 mm×15 mm equaling a surface area of 225 mm². The adhesion strength is given below in the table:

| | | Force translated to Tensile Strength |
|---|---|---|
| | | perpendicular to the grain based on |
| Name | Adhesion Strength (N) | glue applied area (N/mm²) |
| G1 | 2149 | 9.55 |
| G2 | 1986 | 8.82 |
| G3 | 2015 | 8.96 |
| G3a | 2058 | 9.15 |
| G6d | 2065 | 9.18 |
| G6 | 1963 | 8.72 |
| G6a | 1912 | 8.50 |
| G6g | 1942 | 8.63 |
| PO | 1351 | 6.00 |
| VY | 1288 | 5.72 |
| VYD | 0 | 0 |

### Example 5: Particle Board

1-part wood shavings (pine) and 1-part adhesive G1, (from table above) is thoroughly mixed using an 80 mm by 400 mm resin paddle stirrer. A similar 1:1 mixture of sawdust (pine) and adhesive G1 is prepared by the same method. A 3 layered, 45 cm by 25 cm cake is prepared on a piece of baking parchment with each layer pre-pressed by hand. The outer layers of the cake consisted of the sawdust mixture with the wood shaving mixture in the middle. The cake is pressed at 130° C., 50 bar for 15 minutes to a thickness of 8 mm. The hot-press is opened to release any high-pressure steam and the cake is pressed for a further 45 minutes. 2 cm of the board's edges are then removed using a bandsaw and the board is left to cool.

### Example 6: Particle Board Two

2-parts wood shavings (pine) and 1-part adhesive (G1) is thoroughly mixed using an 80 mm by 400 mm resin paddle stirrer. A similar 1:1 mixture of sawdust (pine) and adhesive (G1) is prepared by the same method. A 3 layered, 45 cm by 25 cm cake is prepared on a piece of baking parchment with each layer pre-pressed by hand. The outer layers of the cake consisted of the sawdust mixture with the wood shaving mixture in the middle. The cake is pressed at 130° C., 50 bar for 15 minutes to a thickness of 8 mm. The hot-press is opened to release any high-pressure steam and the cake is pressed for a further 45 minutes. 2 cm of the board's edges are then removed using a bandsaw and the board is left to cool.

### Example 7: Particle Board Three

3-parts wood shavings (pine) and 1-part adhesive (G1) is thoroughly mixed using an 80 mm by 400 mm resin paddle stirrer. A similar 1:1 mixture of sawdust (pine) and adhesive (G1) is prepared by the same method. A 3 layered, 45 cm by 25 cm cake is prepared on a piece of baking parchment with each layer pre-pressed by hand. The outer layers of the cake consisted of the sawdust mixture with the wood shaving mixture in the middle. The cake is pressed at 130° C., 50 bar for 15 minutes to a thickness of 8 mm. The hot-press is opened to release any high-pressure steam and the cake is pressed for a further 45 minutes. 2 cm of the board's edges are then removed using a bandsaw and the board is left to cool.

### Example 8: Ply Board

A 0.5 mm thick sheet of oak (30 mm×50 mm) was coated with G3 adhesive. On top of the adhesive was placed a 0.5 mm thick sheet of birch (30 mm×50 mm). The birch sheet was coated with G3 adhesive. On top of the adhesive was placed a 0.5 mm thick sheet of oak (30 mm×50 mm). The result was a three layer oak-birch-oak plywood precursor. The plywood precursor was pressed at 130° C., 100 bar for 10 minutes. The board was left to cool.

### Example 9: Particle Board Strength

Several particle board specimens were prepared as described in 0134, 0135, 0136 utilizing the G1 formulation and tested in 3-point Bend Jig (aluminium)—according to Standard and specifications EN310:1993. The samples were 8 mm thick, 210 mm long and a width of 50 mm. The Bending Strength was determined based on the maximum applied force before failure occurred:

| Adhesive/ | Tested | Bending strength | Type of board according |
|---|---|---|---|
| Wood Ratio | Fmax [N] | fm [N/mm²] | to Standard EN312: 2010 |
| 50/50 | 168 | 12.6 | P2 |
| 33/66 | 163 | 12.2 | P2 |
| 25/75 | 152 | 11.4 | P2 |

### Example 10: Glue Stick

5 g of yeast and NaCl 100 mg was heated in 10 mL of water at 100° C. for 15 min. Then 5 mL of ethanol was added and the mixture was heated while being stirred for 10 min.

1 g of citric acid was then added and the mixture was stirred at 40° C. until the solution became a think orange paste. Once cooled it was put in a glass vial.

The cooled adhesive can be used as a glue stick to glue paper and/or cardboard together. This cold formulation does not require heat and or pressure to keep paper and/or cardboard bonded together strongly. The mixture can be kept in a sealed vial to prevent the glue from drying.

After 4 hours, the glued cardboard sheets and paper sheets were fully glued. The cardboard layers and paper layers were pulled apart and, instead of the adhesive failing, the paper/cardboard layers tore demonstrating substrate failure rather than cohesive or adhesive failure.

While the disclosure has been particularly shown and described with reference to specific embodiments (some of which are preferred embodiments), it should be understood by those having skill in the art that various changes in form and detail may be made therein without departing from the spirit and scope of the present disclosure as disclosed herein.

All references referred to in the present disclosure are hereby incorporated by reference in their entirety. Various embodiments of the present disclosure may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

The embodiments of the disclosure described above are intended to be merely exemplary; numerous variations and modifications will be apparent to those skilled in the art. All such variations and modifications are intended to be within the scope of the present disclosure as defined in any appended claims.

1. An adhesive formulation comprising:
a. a yeast;
b. a carboxylic acid, wherein the carboxylic acid is a dicarboxylic acid or a tricarboxylic acid; and
c. a solvent, wherein the solvent comprises water and an organic solvent selected from the group consisting of: methanol, ethanol, n-propanol and isopropanol and mixtures thereof; wherein the solvent content present in the adhesive formulation is present in an amount of 30-70 wt %; the solvent has a water content of 65 wt %-95 wt %; and the solvent has an organic solvent content of 5 wt %-35 wt %.

2. The adhesive formulation of claim 1, wherein the carboxylic acid is a tricarboxylic acid.

3. The adhesive formulation of claim 2, wherein the carboxylic acid is citric acid.

4. The adhesive formulation of claim 1, wherein the carboxylic acid is a dicarboxylic acid.

5. The adhesive formulation of claim 4, wherein the carboxylic acid is selected from the group consisting of: oxalic acid, malonic acid, succinic acid, glutaric acid, adipic acid, pimelic acid, suberic acid, azelaic acid, sebacic acid, maleic acid, fumaric acid, glutaconic acid, traumatic acid, muconic acid, glutinic acid, citraconic acid, mesaconic acid and itaconic acid, tartronic acid, mesaxalic acid, malic acid, tartaric acid, oxoloacetic acid, aspartic acid, α-hydroxy glutaric acid, glutamic acid and saccharic acid.

6. The adhesive formulation of claim 1, wherein the carboxylic acid further includes one or more moieties selected from the group consisting of: ester moieties, amide moieties, hydroxyl moieties and aldehyde moieties.

7. The adhesive formulation of claim 1, further comprising an additional component, wherein the additional component has two or more independently selected moieties selected from the group consisting of: carboxylic acid moieties, ester moieties, amide moieties, hydroxyl moieties and aldehyde moieties.

8. The adhesive formulation of claim 7, wherein the additional component is gluten.

9. The adhesive formulation of claim 1, wherein the yeast is virgin yeast or is yeast derived from a waste source.

10. The adhesive formulation of claim 1, wherein the yeast is present in the formulation in an amount of 10-50% (w/w) based upon the dried yeast content.

11. The adhesive formulation of claim 1, wherein the carboxylic acid is present in the formulation in an amount of 5-30% (w/w).

12. The adhesive formulation of claim 1, further comprising a colourant.

13. The adhesive formulation of claim 1, further comprising a perfume.

14. The adhesive formulation of claim 1, wherein the pH of the formulation is between 5-6.

15. A method of joining a first and second item comprising:
a. contacting at least the first item with the adhesive formulation of claim 1 to prepare a formulation-coated first item;
b. contacting the second item with the adhesive formulation-coated first item to prepare a joined item; and
c. allowing the adhesive formulation to cure thereby joining the first and second item.

16. The method of claim 15, wherein after step (b) and before step (c), applying heat and/or pressure to the joined item of step (b).

17. The method of claim 15, wherein the items are cardboard; or wherein the items are sawdust and/or wood chips and/or sheets of wood.

18. The method of making an adhesive formulation of claim 1 comprising:
a. combining: (1) dried yeast; (2) carboxylic acid, wherein the carboxylic acid is a dicarboxylic acid or a tricarboxylic acid; and (3) solvent, wherein the solvent comprises water and an organic solvent selected from the group consisting of: methanol, ethanol, n-propanol and isopropanol, and mixtures thereof; wherein the solvent content present in the adhesive formulation is present in an amount of 30-70 wt %; the solvent has a water content of 65 wt %-95 wt %; and the solvent has an organic solvent content of 5 wt %-35 wt %;
b. mixing the combination of (1), (2) and (3) to produce the adhesive formulation;
or
a. combining: (1) a mixture of dried yeast and dried carboxylic acid, wherein the carboxylic acid is a dicarboxylic acid or a tricarboxylic acid; and (2) solvent, wherein the solvent comprises water and an organic solvent selected from the group consisting of: methanol, ethanol, n-propanol and isopropanol and mixtures thereof; wherein the solvent content present in the adhesive formulation is present in an amount of 30-70 wt %; the solvent has a water content of 65 wt %-95 wt %; and the solvent has an organic solvent content of 5 wt %-35 wt %;
b. mixing the combination of (1) and (2) to produce the adhesive formulation.

19. A particle board or ply board wood product obtainable from a process comprising contacting an adhesive formulation of claim 1 with sawdust and/or wood chips and/or sheets of wood and allowing the adhesive formulation to cure thereby joining the sawdust and/or wood chips and/or sheets of wood.

20. The particle board or ply board wood product of claim 19, which is obtained by said process.

21. A cardboard product obtainable from a process comprising contacting an adhesive formulation of claim 1 with a first cardboard or paper component and a second cardboard or paper component and allowing the adhesive formulation to cure thereby joining the first and second cardboard or paper components.

22. The cardboard product of claim 21, which is obtained by said process.
